(19) United States
(12) Patent Application Publication
(10) Pub. No.: US 2003/0226768 A1
(43) Pub. Date: Dec. 11, 2003

(54) Method for detecting macromolecular biopolymers by means of an electrode arrangement

(76) Inventors: Franz Hoffman, Munchen (DE); Richard Johannes Luyken, Munchen (DE)

Correspondence Address: Jeffrey R Stone, Briggs and Morgan, 2400 Ids Center, Minneapolis, MN, 55402, US

(21) Appl. No.: 10/169,624

(22) PCT Filed: Mar. 29, 2001
(86) PCT No.: PCT/DE01/01244

(30) Foreign Application Priority Data
Mar. 30, 2000 (DE) 100-15-819.6

(51) Int. Cl. G01N 27/26

(52) U.S. Cl. 205/777.5; 205/778

(57) ABSTRACT

The invention relates to electrodes which are provided with molecules that can bind macromolecular biopolymerss. A first electric measurement is carried out on the electrodes. A medium is contacted to said electrodes in such a way that biopolymers can specifically bind to first molecules or second molecules which are applied to the electrodes, when macromolecular biopolymers are present in the medium. Unbound first or second molecules are removed from the respective electrode and a second electric measurement is carried out. The macromolecular biopolymers are detected according to the measurements.

The invention relates to a method for detecting macromolecular biopolymers by means of an electrode arrangement.

Such a method is known from [1].

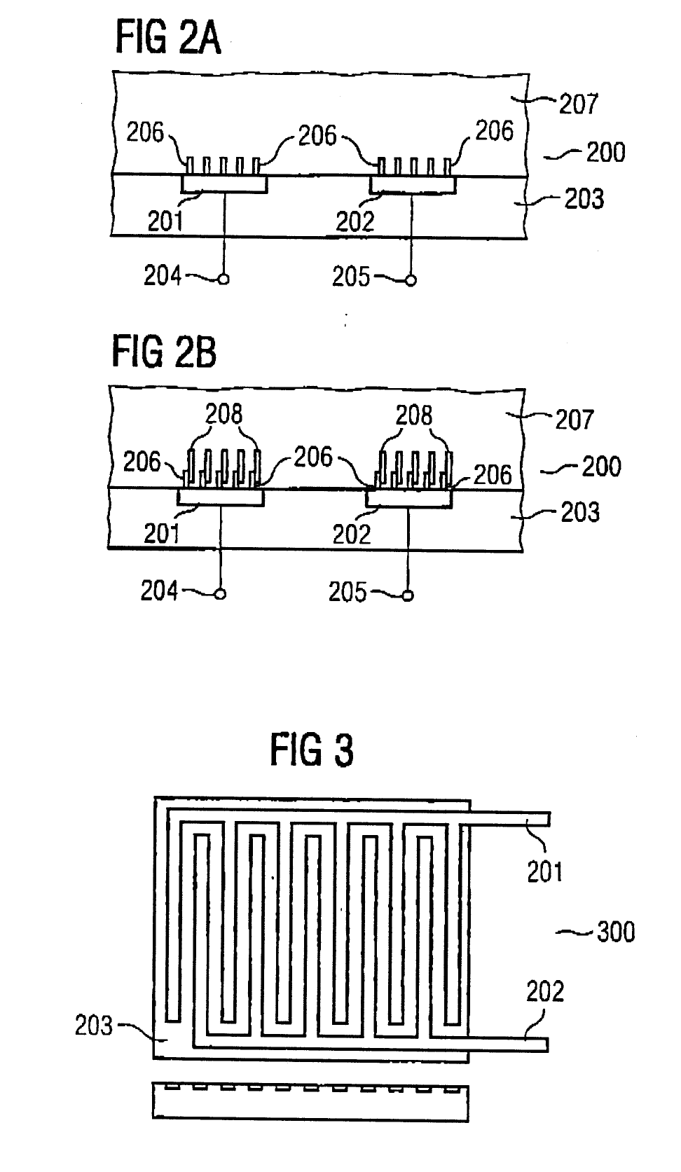

FIG. 2a and FIG. 2b show such a sensor, as described in [1]. The sensor 200 has two electrodes 201, 202 made of gold, which are embedded in an insulator layer 203 made of insulator material. Electrode terminals 204, 205, to which the electrical potential applied to the electrodes 201, 202 can be delivered, are connected to the electrodes 201, 202. The electrodes 201, 202 are arranged as planar electrodes. DNA probe molecules 206 are immobilized on each electrode 201, 202 (cf. FIG. 2a). The immobilization is carried out according to the so-called gold-sulfur coupling. The analyte to be studied, for example an electrolyte 207, is applied to the electrodes 201, 202.

If DNA strands 208 with a sequence which is complementary to the sequence of the DNA probe molecules are contained in the electrolyte 207, then these DNA strands 208 hybridize with the DNA probe molecules 206 (cf. FIG. 2b)

Hybridization of a DNA probe molecule 206 and a DNA strand 208 takes place only if the sequences of the respective DNA probe molecule 206 and of the corresponding DNA strand 208 are complementary to one another. If this is not the case, then no hybridization takes place. A DNA probe molecule with a predetermined sequence is hence respectively able to bind, i.e. hybridize, only a particular DNA strand, namely the one with the complementary sequence in each case.

If hybridization takes place, then as can be seen from FIG. 2b, the value of the impedance between the electrode 201, 202 becomes modified. This modified impedance is determined by applying an AC voltage with an amplitude of approximately 50 mV to the electrode terminals 204, 205 and by determining the resulting current by means of connected measuring instrument (not shown).

In the event of hybridization, the capacitive component of the impedance between the electrodes 201, 202 is reduced. This is attributable to the fact that both the DNA probe molecules 206 and the DNA strands 208, which may hybridize with the DNA probe molecules 206 if appropriate, are non-conductive and therefore clearly shield the respective electrode 201, 202 electrically to a certain extent.

In order to improve the measurement accuracy, it is also known from [4] to use a plurality of electrode pairs 201, 202 and to connect them in parallel, they being clearly arranged interdigitated with one another, so that a so-called interdigital electrode 300 is obtained. The dimensioning of the electrodes and the distances between the electrodes are of the order of the length of the molecules to be detected, i.e. the DNA strand 208 or less, for example in the region of 200 nm and less.

A further procedure for studying the electrolyte with respect to the existence of a DNA strand with a predetermined sequence is known from [2]. In this procedure, the DNA strands with the desired sequence are marked and, on the basis of the reflection properties of the marked molecules, the existence thereof is determined. To that end, light in the visible wavelength range is shone onto the electrolyte, and the light reflected by the electrolyte, in particular by the DNA strand to be registered, is detected. On the basis of the reflection response, i.e. in particular on the basis of the detected, reflected light beams, the question of whether or not the DNA strand to be registered, with the correspondingly predetermined sequence, is or is not contained in the electrolyte is determined.

This procedure is highly elaborate, since very accurate knowledge about the reflection response of the correspondingly marked DNA strands is required and, furthermore, it is necessary to mark the DNA strands before the start of the method.

Furthermore, very accurate adjustment of the detection means for detecting the reflected light beams is required, in order to be able to detect the reflected light beams at all.

This procedure is therefore expensive, complicated and highly sensitive to perturbing effects, so that it is very easy for the measurement result to be vitiated.

It is furthermore known from affinity chromatography ([3]) to use immobilized low molecular weight molecules, in particular ligands with high specificity and affinity, in order to specifically bind peptides and proteins, e.g. enzymes, in the analyte.

The electrical parameter which is evaluated in the method known from [1] is the capacitance between the electrodes, or the impedance of the two electrodes.

In order to achieve the greatest possible sensitivity when detecting macromolecular biopolymers, it is desirable to arrange the greatest possible number of field lines between the two electrodes in the volume in which the hybridization of the DNA strands having predetermined sequences with the DNA probe molecules, in general the binding of macromolecular molecules to immobilized DNA probe molecules, takes place.

In the known method, the impedance, or the capacitance, is detected in terms of its change, when only DNA probe molecules are present, in relation to the case in which DNA probe molecules are hybridized with the DNA strands to be detected.

It is an object of the invention to provide a method for detecting macromolecular biopolymers, with which a more robust measurement signal is achieved, i.e. a larger change in the impedance signal between the state in which no holding molecules, or exclusively holding molecules, are applied to the electrodes and that in which binding with the macromolecular biopolymers to be registered has at least partially taken place.

The object is achieved by the method having the features according to the independent patent claim.

In the scope of the method, an electrode arrangement which has a first electrode and a second electrode is used. The first electrode may be provided physically (i.e. by adsorption) or chemically (i.e. by means of covalent bonds) with first molecules which can bind macromolecular biopolymers of a first type. The second electrode may be provided physically or chemically with second molecules which can bind macromolecular biopolymers of a second type.

The term “macromolecular biopolymers” is intended to mean, for example, proteins or peptides or even DNA strands with a respectively predetermined sequence.

If proteins or peptides are intended to be detected as the macromolecular biopolymers, then the first molecules and the second molecules are ligands, for example active substances with a possible binding activity, which bind the proteins or peptides to be detected to the respective electrode on which the corresponding ligands are arranged.

Suitable ligands include enzyme agonists or enzyme antagonists, pharmaceuticals, sugars or antibodies or any molecule which has the ability to specifically bind proteins or peptides.

In the scope of this description, the term “probe molecule” is intended to mean both a ligand and a DNA probe molecule.

The electrode arrangement may be a plate electrode arrangement or an interdigitated electrode arrangement, as is known from [1 ].

Furthermore, various arrangements of the parallel connection of electrodes may be provided in the electrode arrangement; for example, the electrodes may be configured as cylindrical elements which are respectively arranged concentrically around one another and are electrically insulated from one another, for example, by means of a suitable dielectric so that an electric field is set up between the electrodes.

If DNA strands with a predetermined sequence, which are intended to be detected by means of the electrode arrangement, are used as the macromolecular biopolymers then, by means of the electrode arrangement, DNA strands with a predetermined first sequence can be hybridized with DNA probe molecules, having a sequence complementary to the first sequence, as the first molecules on the first electrode. In order to detect a DNA strand with a predetermined second sequence by means of second molecules on the second electrode, DNA probe molecules which have a sequence that is complementary to the second sequence of the DNA strand are used as the second molecules.

In a first method stage, a first electrical measurement is carried out on the electrodes; the first molecules and/or the second molecules may or may not already be arranged on the electrodes during the first electrical measurement.

A medium, for example an electrolyte, is brought into contact with the electrodes. This is done in such a way that, in the event that macromolecular biopolymers of the first type are contained in the medium, they can bind to the first molecules. In the event that macromolecular biopolymers of the second type are contained in the medium, they can bind to the second molecules.

It should be noted that the macromolecular biopolymers of the first type bind only to the first molecules on the first electrode, and that the macromolecular biopolymers of the second type bind only to the second molecules on the second electrode.

After having waited for a sufficient length of time, so that the macromolecular biopolymers can bind to the first molecules, or to the second molecules, unbound first molecules or second molecules are removed from the respective electrode on which they are located.

In the event that the probe molecules are DNA strands, this is done, for example, enzymatically by means of an enzyme which selectively degrades single-stranded DNA. In this case, the selectivity of the degrading enzyme for single-stranded DNA needs to be taken into account. If the enzyme selected for the degradation of unhybridized DNA single strands does not have this selectivity, then the hybridized double-stranded DNA to be detected may possibly be undesirably degraded as well.

In particular, in order to remove the unbound first or second DNA probe molecules from the respective electrode, it is possible to use DNA nucleases, for example a mung bean nuclease, nuclease P1 or nuclease S1. The use of DNA polymerases which are capable of degrading single-stranded DNA owing to their 5′→3′ or their 3′→5′ exonuclease activity, may likewise be used.

In the event that the probe molecules are low molecular weight ligands, they may also be removed enzymatically if they are unbound.

To that end, the ligands are bonded covalently to the electrode via an enzymatically cleavable bond, for example via an ester bond.

In this case, for example, it is possible to use a carboxyl ester hydrolase (esterase) in order to remove unbound ligand molecules. This enzyme hydrolyzes that ester bond between the electrode and the respective ligand molecule which has not been bound by a peptide or protein. Conversely, owing to their reduced stearic accessibility due to the molecular mass of the bound peptide or protein, the ester bonds between the electrode and those molecules which have participated in a binding interaction with peptides or proteins remain intact.

After the removal of the unbound first molecules or second molecules has taken place, a second electrical measurement is carried out on the electrodes.

The values determined from the first electrical measurement and the second electrical measurement are compared with one another, and if the capacitance values differ in such a way that the difference in the determined values is greater than a predetermined threshold value, then it is assumed that macromolecular biopolymers have bound to probe molecules, or in general to the first or second molecules, and this has caused the change in the electrical signal at the electrodes.

If the difference between the values of the first electrical measurement and the second electrical measurement is greater than a predetermined threshold, then the result delivered is that the corresponding macromolecular biopolymers, which specifically bind the first molecules or second molecules have been bound, and therefore that the corresponding macromolecular biopolymers were contained in the medium.

In this way, the macromolecular biopolymers have been detected.

The first electrical measurement and the second electrical measurement may be carried out by measuring the capacitance between the electrodes.

Alternatively, the electrical resistance of the individual electrodes may also be determined.

In general, an impedance measurement, in the scope of which both the capacitance between the electrodes and the electrical resistances are measured, may be carried out as the first electrical measurement and as the second electrical measurement.

Clearly, the invention may be regarded as consisting in the following: by removing unbound first molecules or second molecules from the respective electrode, the difference between the determined values of the electrical signals between the first electrical measurement and the second electrical measurement, during the bonding of macromolecular biopolymers, is further increased by the fact that the unbound molecules, which vitiate the measurement result, no longer have any perturbing effect on the measurement result.

An exemplary embodiment of the invention is represented in the figures and will be explained in more detail below.

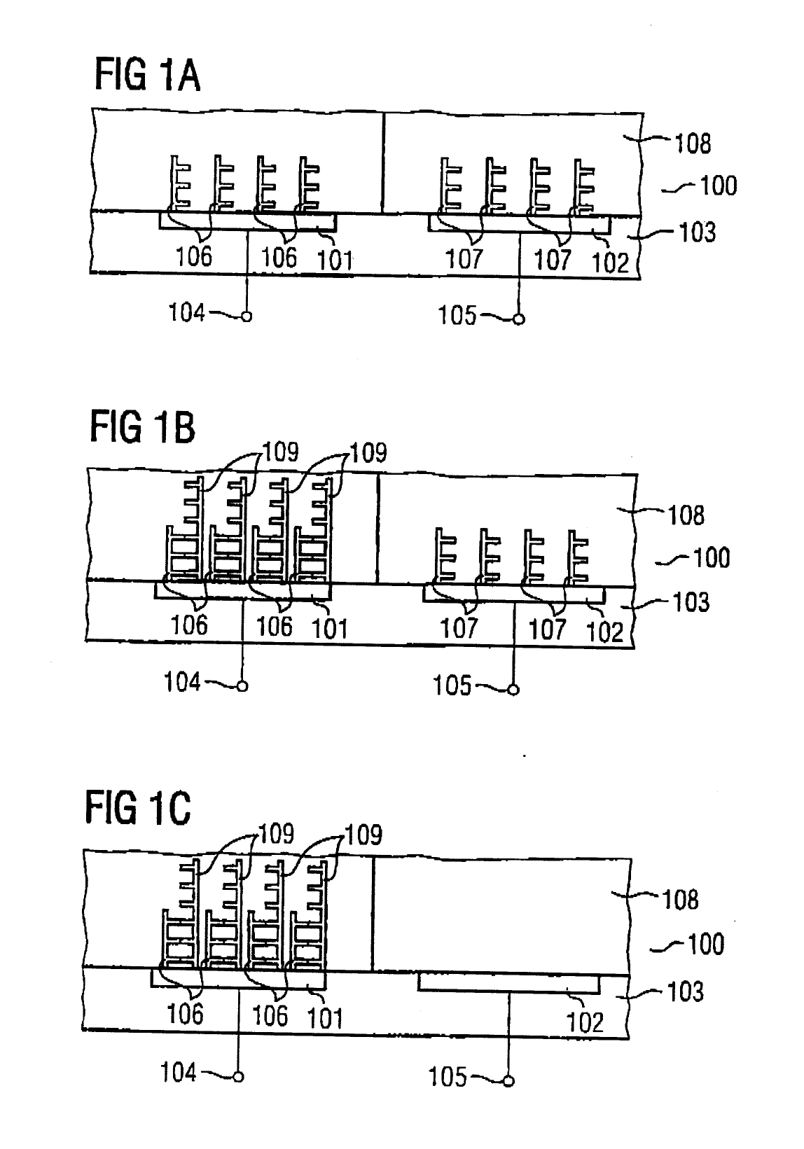

FIGS. 1a to 1c show an electrode arrangement in different method states, with the aid of which the method according to an exemplary embodiment of the invention will be explained;

FIGS. 2a and 2b show a sketch of two planar electrodes, by means of which the existence of DNA strands to be detected in an electrolyte (FIG. 2a) or their non-existence (FIG. 2b) can be registered;

FIG. 3 shows interdigitated electrodes according to the prior art;

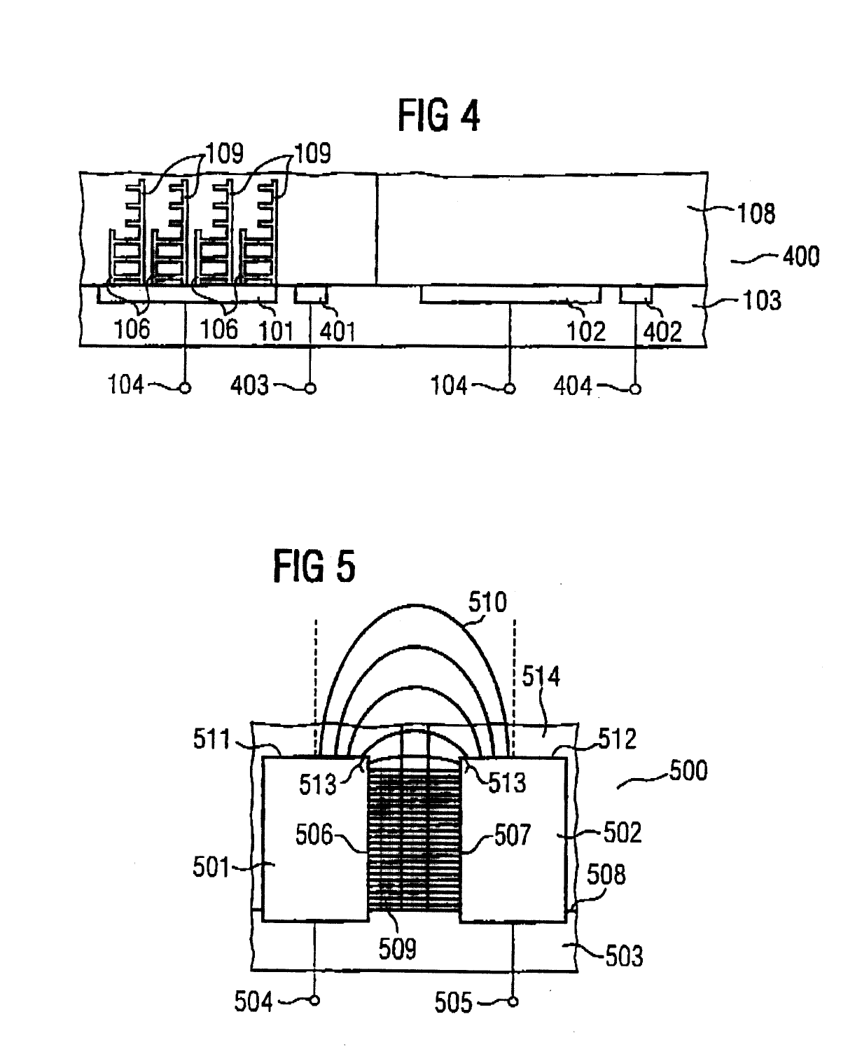

FIG. 4 shows a sketch of an electrode arrangement which is used in the scope of a second exemplary embodiment.

FIG. 5 shows a biosensor according to an exemplary embodiment of the invention;

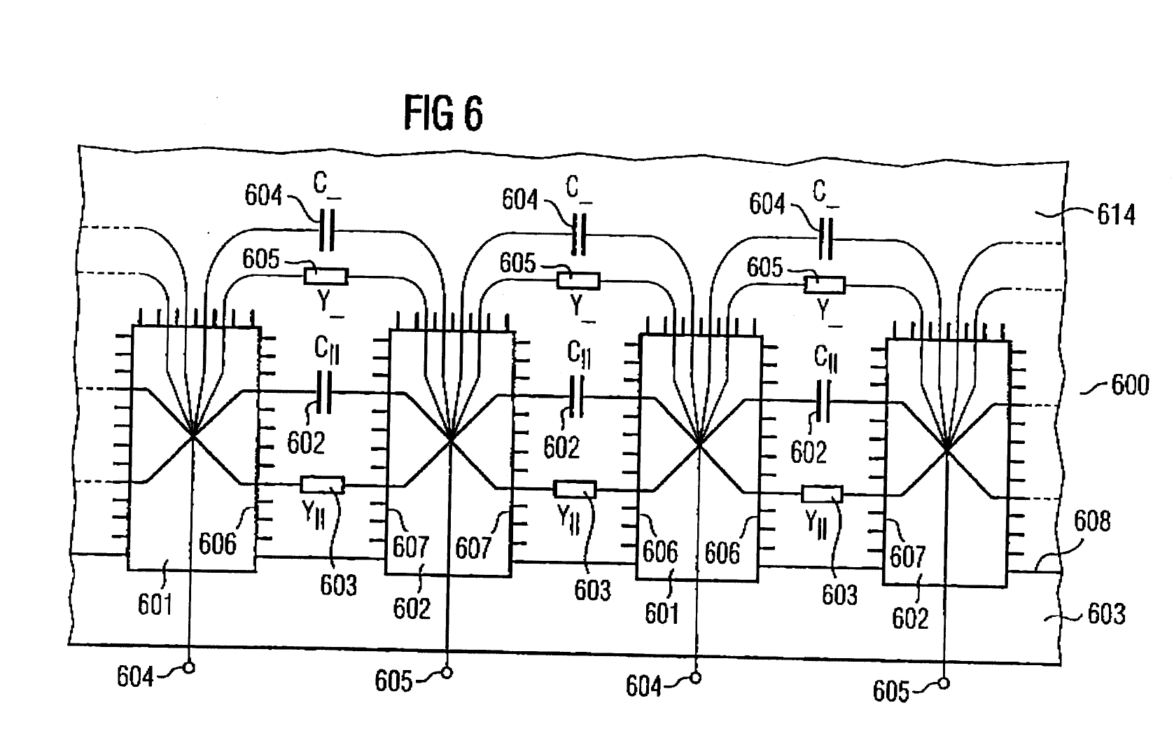

FIG. 6 shows a cross section of a biosensor with two electrodes, which are arranged as an interdigitated electrode arrangement;

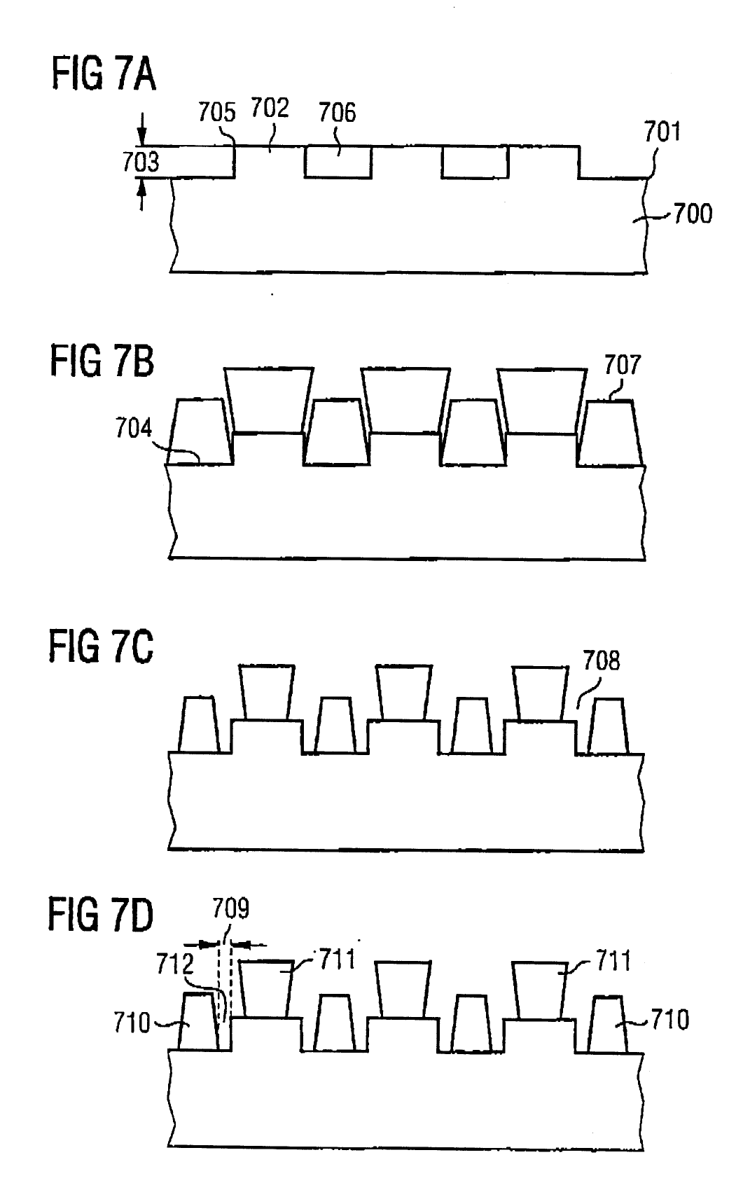

FIGS. 7a to 7d show cross-sectional views of an interdigitated electrode in four method states in a method for producing a biosensor according to an exemplary embodiment of the invention;

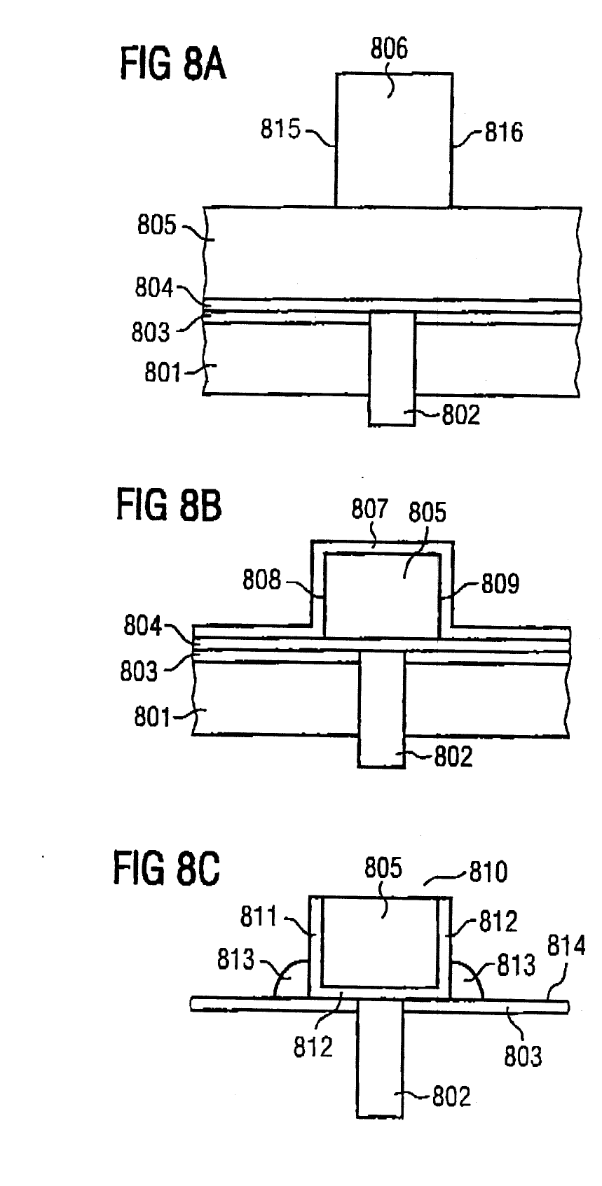

FIGS. 8a to 8c show cross-sectional views of a biosensor during individual method stages of the method for producing an electrode of the biosensor according to a further exemplary embodiment of the invention;

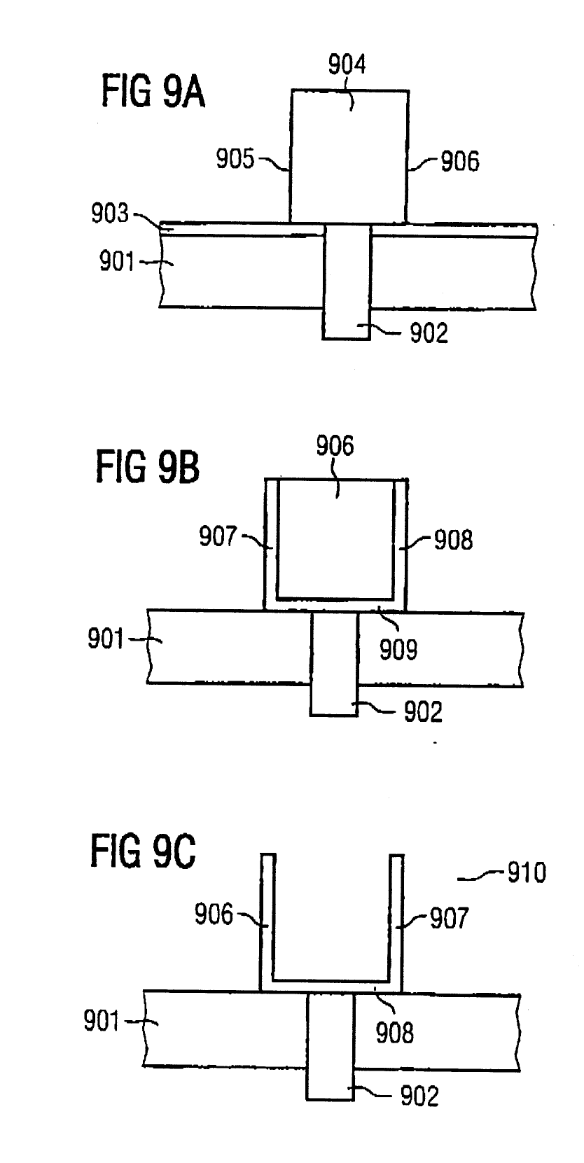

FIGS. 9a to 9c show cross-sectional views of a biosensor during individual method stages of the method for producing an electrode of the biosensor according to a further exemplary embodiment of the invention;

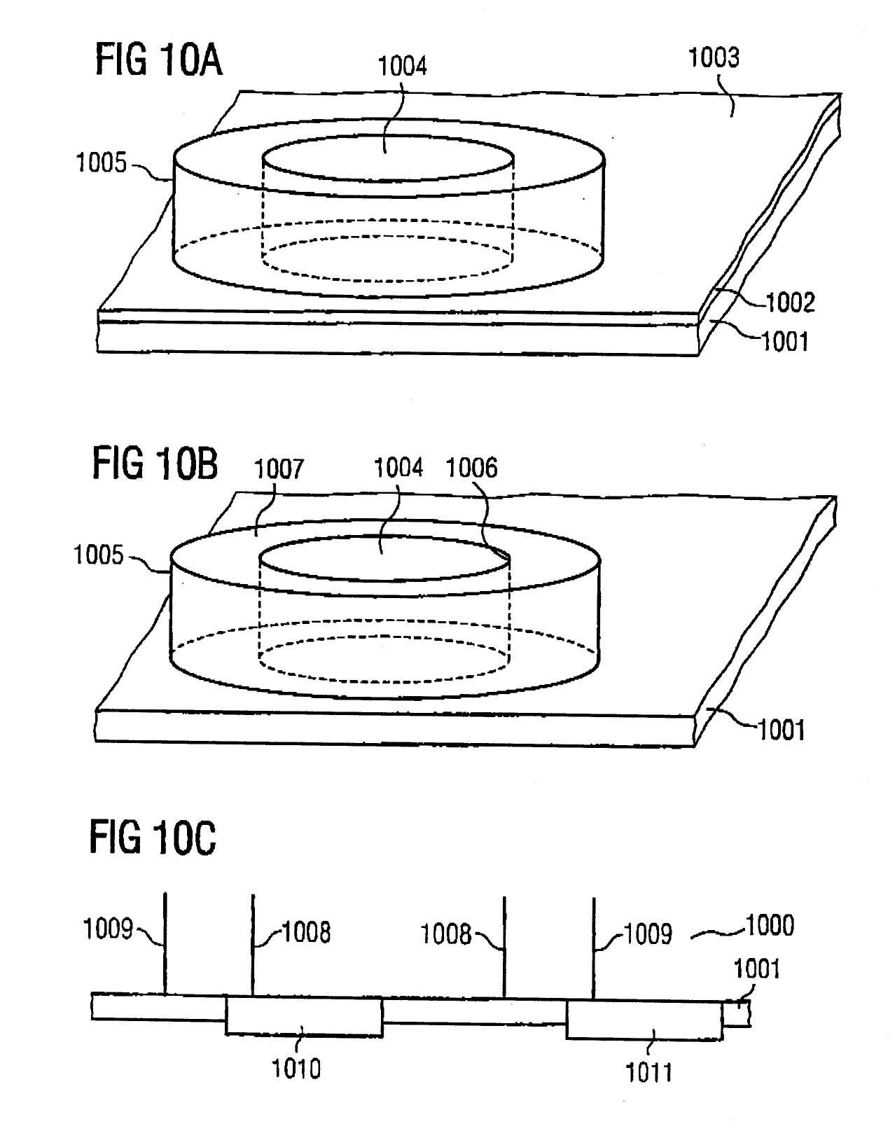

FIGS. 10a to 10c respectively show a cross section of a biosensor at various times during the production method according to a further exemplary embodiment of the invention;

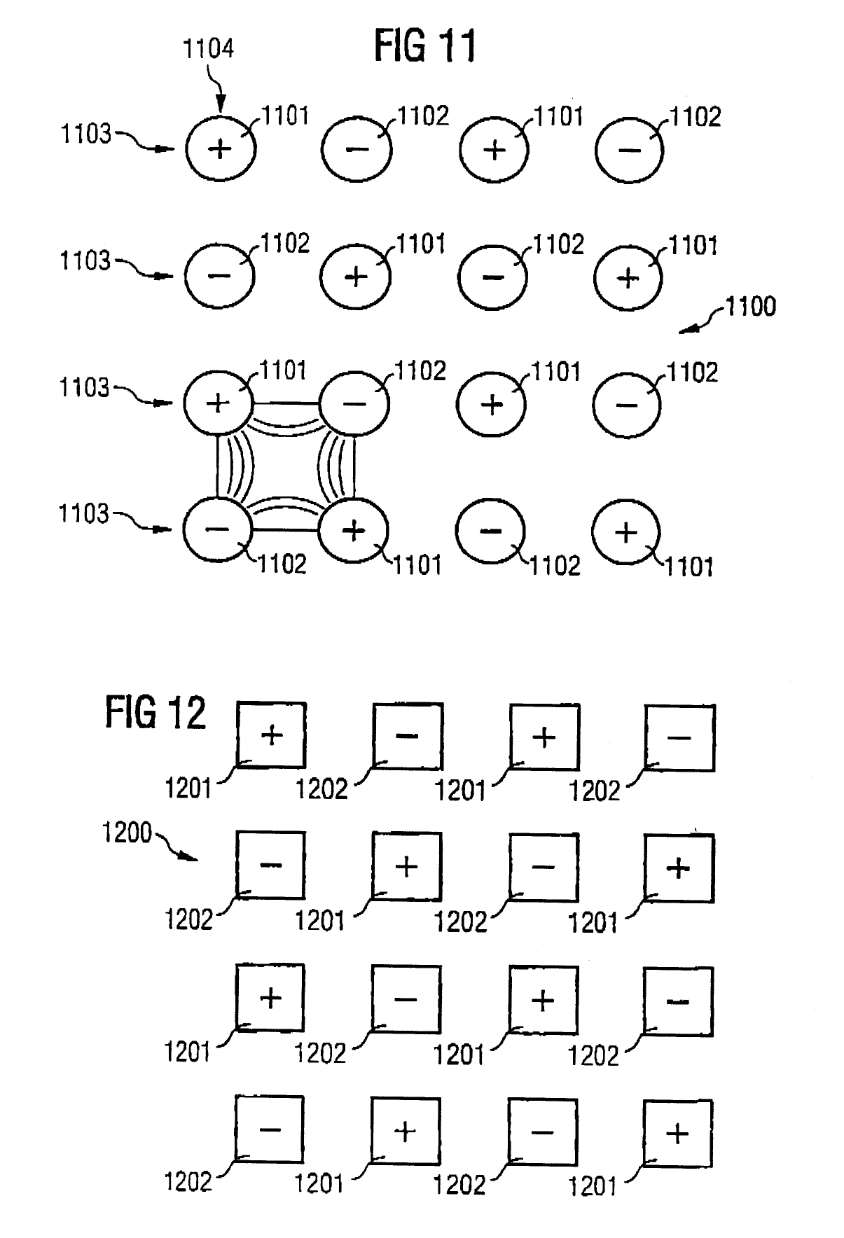

FIG. 11 shows a plan view of a biosensor array according to an exemplary embodiment of the invention with cylindrical electrodes;

FIG. 12 shows a plan view of a biosensor array according to an exemplary embodiment of the invention with cuboid electrodes;

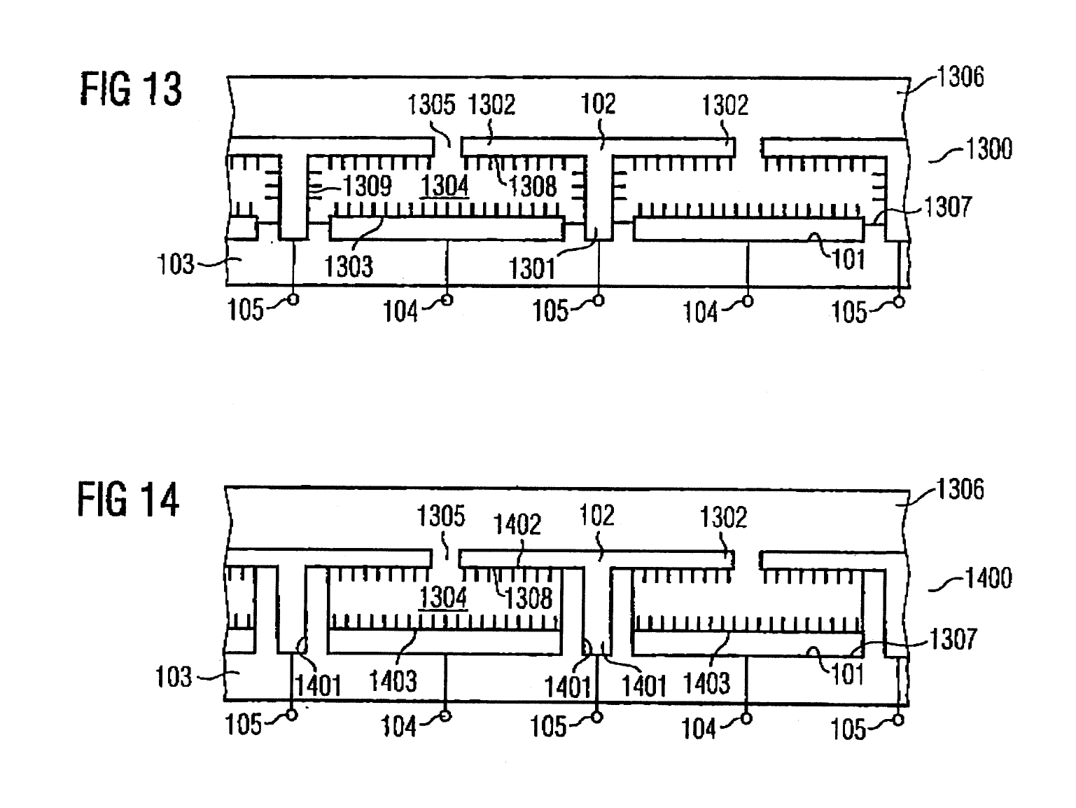

FIG. 13 shows a cross-sectional view of a biosensor according to a further exemplary embodiment of the invention;

FIG. 14 shows a cross-sectional view of a biosensor according to a further exemplary embodiment of the invention; and

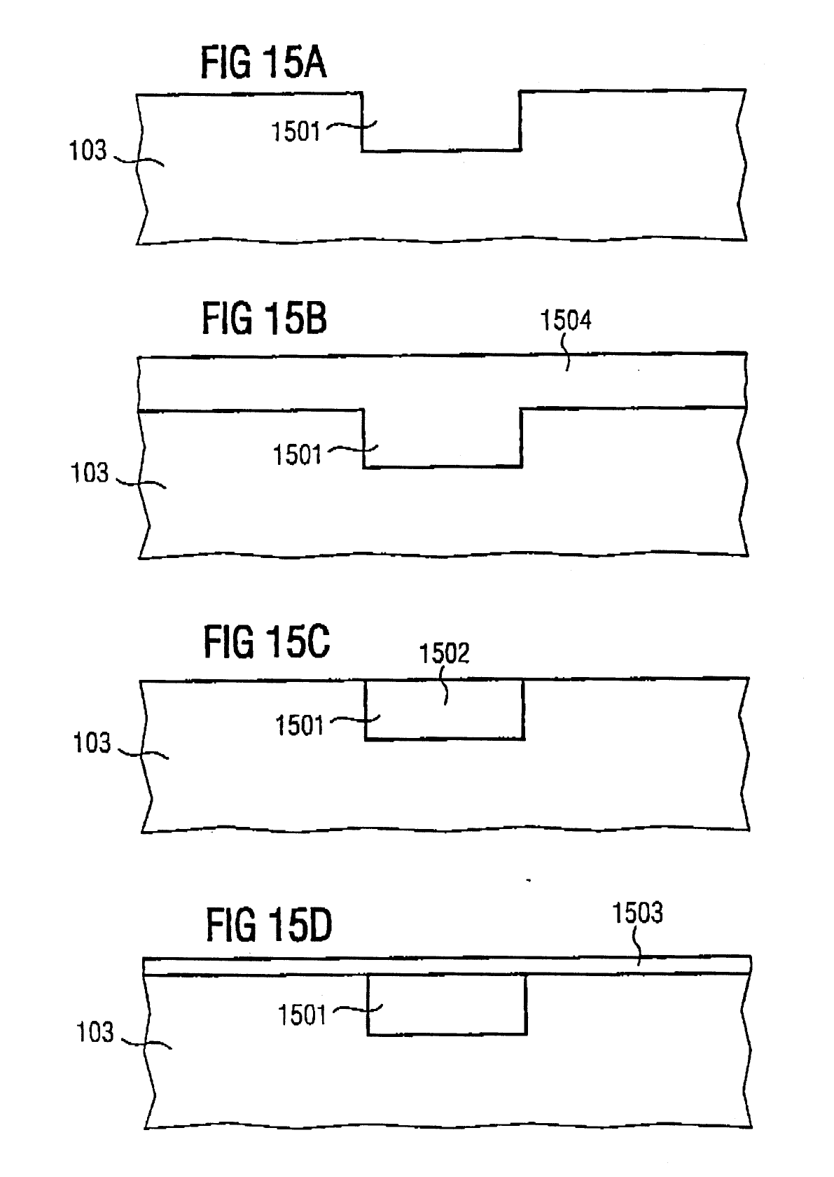

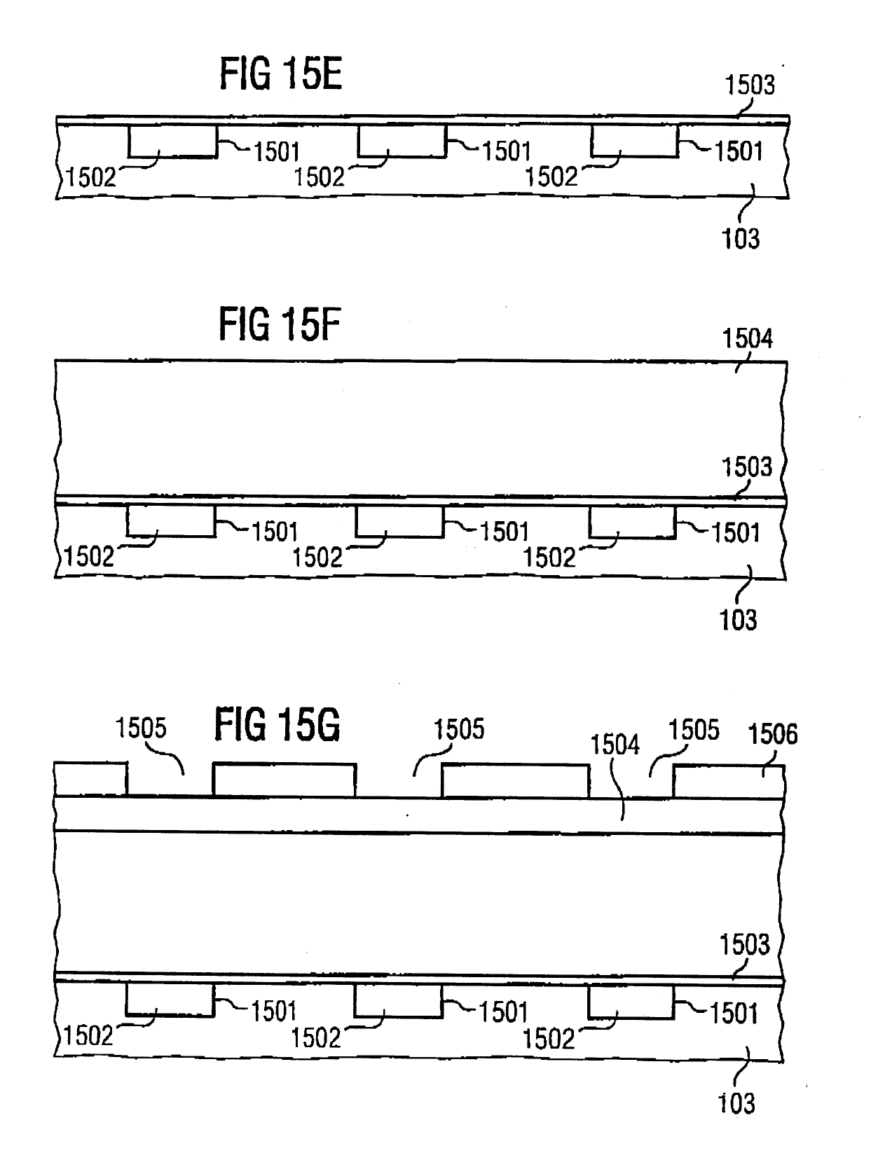

FIGS. 15a to 15g show cross-sectional views of a biosensor during individual method stages of a production method according to a further exemplary embodiment of the invention;

FIG. 1a shows an electrode arrangement 100 with a first electrode 101 and a second electrode 102, which are arranged in an insulator layer 103 made of insulator material.

The first electrode 101 is provided with a first electrical terminal 104, and the second electrode 102 is provided with a second electrical terminal 105.

The first electrode 101 and the second electrode 102 are made of gold.

Alternatively, the electrodes 101 and 102 may also be made of silicon oxide. They may be coated with a material which is suitable for immobilizing the probe molecules thereon.

For example, known alkoxysilane derivatives may be used, such as

3-glycidoxypropylmethyloxysilane,

3-acetoxypropyltrimethoxysilane,

3-aminopropyltriethoxysilane,

4-(hydroxybutyramido)propyltriethoxysilane,

3-N,N-bis(2-hydroxyethyl)aminopropyltriethoxysilane, or other related materials which are capable, with one of their ends, of forming a covalent bond with the surface of the silicon oxide and, with their other end, of offering a chemically reactive group, such as an epoxy, acetoxy, amine or hydroxyl radical, for reaction to the probe molecules to be immobilized.

If a probe molecule to be immobilized reacts with such an activated group, then it will be immobilized on the surface of the coating on the electrode via the selected material as a kind of covalent linker.

DNA probe molecules 106, 107 are applied to the immobilized regions of the electrodes 101, 102.

On the first electrode 101, first DNA probe molecules 106 with a sequence complementary to a predetermined first DNA sequence are applied.

On the second electrode 102, second DNA probe molecules 107 with a sequence which is complementary to a predetermined second DNA sequence are applied.

Sequences of DNA strands that are respectively complementary to the sequences of the probe molecules can hybridize onto the pyrimidine bases adenine (A), guanine (G), thymine (T) or cytosine (C) in the usual way, i.e. base pairing via hydrogen bridge bonds between A and T or between C and G.

FIG. 1a furthermore shows an electrolyte 108, which is brought into contact with the electrodes 101, 102 and the DNA probe molecules 106, 107.

FIG. 1b shows the electrode arrangement 100 for the case in which DNA strands 109 with the predetermined first sequence, which is complementary to the sequence of the first DNA probe molecules 106, are contained in the electrolyte 108.

In this case, the DNA strands 109 complementary to the first DNA probe molecules hybridize with the first DNA probe molecules 106, which are applied on the first electrode 101.

Since the sequences of DNA strands hybridize only with the respectively specific complementary sequence, the DNA strands complementary to the first DNA probe molecules do not hybridize with the second DNA probe molecules 107.

As can be seen from FIG. 1b, the result after hybridization has taken place is that hybridized molecules, i.e. double-stranded DNA molecules, are applied on the first electrode 101. On the first electrode, only the second DNA probe molecules 107 are still present as single-stranded molecules.

In a further stage, hydrolysis of the single-stranded DNA probe molecules 107 of the second electrode 102 is brought about by means of a biochemical method, for example by means of DNA nucleases in the electrolyte 108.

In this case, the selectivity of the degrading enzyme for single-stranded DNA needs to be taken into account. If the enzyme selected for the degradation of unhybridized DNA single strands does not have this selectivity, then the hybridized double-stranded DNA to be detected may possibly be undesirably degraded as well, which would lead to vitiation of the measurement result.

After having removed the single-strand DNA probe molecules, i.e. the second DNA probe molecules 107 on the second electrode 102, only the double-strand molecules of the hybridized DNA strands with the sequence complementary to the first sequence of the first DNA probe molecules 106 are present (cf. FIG. 1c).

For example, in order to remove the single-strand DNA probe molecules 107 on the second electrode, one of the following substances may be added:

mung bean nuclease,

nuclease P1, or

nuclease S1.

DNA polymerases which, owing to their 5′→3′ exonuclease activity or their 3′→5′ exonuclease activity, are capable of degrading single-stranded DNA may likewise be used for this purpose.

If a sample substance, which contains DNA strands with a sequence that is complementary to the sequence of the second DNA probe molecules 107 on the second electrode 102, is added to the electrolyte, then hybridization of the added DNA strands having the sequence complementary to the second DNA probe molecules 107 takes place with the second DNA probe molecules 107, and the first DNA probe molecules 106 remain as single-strand probe molecules on the first electrode.

According to the method represented in FIG. 1b, these are removed from the first electrode 101 in a similar way by means of the biochemical method described above.

By means of a measuring instrument (not shown) connected to one of the electrode terminals 104, 105, according to this first exemplary embodiment a capacitance measurement is carried out between the electrodes 101, 102 in the state represented in FIG. 1a, i.e. in the unhybridized state.

In the scope of the first capacitance measurement, a reference capacitance value is determined and stored in a memory (not shown).

A second capacitance measurement is carried out after the single-stranded DNA probe molecules 107 have been removed from the respective electrode.

This is again carried out by means of the measuring instrument, which is not represented. By means of the second capacitance measurement, a capacitance value is determined which is compared with the reference capacitance value.

If the difference between these capacitance values is greater than a predetermined threshold value, then this means that DNA strands that have hybridized either with the first DNA probe molecules or the second DNA probe molecules were contained in the electrolyte 108.

In this case, a corresponding output signal is delivered by the measuring instrument to the user of the measuring instrument.

In this context, it should be pointed out that, depending on the substance which is used for removing the single-strand DNA probe molecules 107 on the second electrode, the single-stranded component of the hybridized DNA strands 109 may remain behind or may also be removed as well.

FIG. 4 shows a sensor arrangement 400 in which, instead of the capacitance measurement, an impedance measurement is carried out in a second exemplary embodiment.

The sensor arrangement 400 represented in FIG. 4 is represented in the state in which hybridization of the DNA strands complementary to the first DNA probe molecules 106 has already taken place with the first DNA probe molecules 106, and after the second DNA probe molecules 107, which are not hybridized, have been removed from the second electrode 102.

For each electrode 101, 102, a reference electrode 401, 402 is respectively provided, and these are designed in such a way that the DNA probe molecules 106, 107 do not adhere to this reference electrode 401, 402.

This may be guaranteed by selecting a material for the reference electrode 401, 402 which does not permit any sulfur bonding.

Alternatively, undesired adhesion of the DNA probe molecules on the reference electrode may be prevented if the coating material suitable for immobilizing the DNA probe molecules (see above) is not applied in advance to the reference electrode. Therefore, there will not be any chemically reactive groups on the reference electrode, which would otherwise bond covalently with the DNA probe molecules so as to immobilize them there.

Alternatively, this may be guaranteed by applying a sufficiently large negative electric field, which ensures that the negatively charged DNA probe molecules 106, 107 do not adhere to the reference electrodes 401, 402.

Each reference electrode 401, 402 is coupled to an electrical reference terminal 403, 404.

In the scope of the second exemplary embodiment, a first impedance measurement is carried out in the uncoated state, i.e. for example in a state without probe molecules 106, 107 on the electrodes 101, 102 or with unhybridized DNA probe molecules 106, 107.

After the single-stranded DNA probe molecules have been removed, following possible hybridization of the appropriate DNA probe molecules 106, 107 with DNA strands having the predetermined sequence complementary to the respective DNA probe molecule 106, 107, a second impedance measurement is carried out in the known way and, on the basis of the possibly changed impedance values, the question of whether or not hybridization of probe molecules 106, 107 and DNA strands 109 with a respectively complementary sequence has taken place is determined.

The intention is not restricted to an electrode arrangement with only two electrodes, and in particular not to the plate electrode arrangement explained according to the exemplary embodiment.

Without modifying the method, it is possible to carry it out in the scope of an interdigitated electrode arrangement or else with an arbitrary number of different electrodes, to which different DNA probe molecules with different sequences are applied, so that it is possible to detect a plurality of different DNA strands with different sequences in an array fashion.

It should furthermore be pointed out that the invention is not restricted to use in the case of a planar electrode arrangement.

Rather, the invention can also be used in the case of an electrode arrangement in which the first electrode and the second electrode are arranged, relative to one another, in such a way that essentially uncurved field lines of an electric field produced between the first electrode and the second electrode can be formed between the first holding region and the second holding region.

A few such electrode arrangements, and methods for their production, will be explained in more detail below.

FIG. 5 shows a biosensor chip 500 with a further electrode configuration.

The biosensor chip 500 has a first electrode 501 and a second electrode 502, which are arranged on an insulator layer 503 in such a way that the first electrode 501 and the second electrode 502 are electrically insulated from one another.

The first electrode 501 is coupled to a first electrical terminal 504, and the second electrode 502 is coupled to a second electrical terminal 505.

The electrodes 501, 502 have a cuboid structure, with a first electrode face 506 of the first electrode 501 and a first electrode face 507 of the second electrode 502 facing one another while being aligned essentially parallel.

This is achieved, according to this exemplary embodiment, by the fact that the electrodes 501, 502 have side walls 506, 507 which are essentially perpendicular with respect to the surface 508 of the insulator layer 503, and which respectively form the first electrode face 506 of the first electrode 501 and the first electrode face 507 of the second electrode 502.

If an electric field is applied between the first electrode 501 and the second electrode 502, then owing to the electrode faces 506, 507 which are aligned essentially parallel with one another, a field line profile is produced with field lines 509 which are essentially uncurved between the surfaces 506, 507.

Curved field lines 510 occur only between a second electrode face 511 of the first electrode 501 and a second electrode face 512 of the second electrode 502, which respectively form the upper surface for the electrodes 501, 502, as well as in an edge region 513 between the electrodes 501, 502.

The first electrode faces 506, 507 of the electrodes 501, 502 are formed as holding regions for holding probe molecules, which can bind macromolecular biopolymers that are to be detected by means of the biosensor 500.

The electrodes 501, 502 are made of gold according to this exemplary embodiment.

Covalent bonds are produced between the electrodes and the probe molecules, the sulfur for forming gold-sulfur coupling being present in the form of a sulfide or a thiol.

For the case in which DNA probe molecules are used as the probe molecules, such sulfur functionalities are part of a modified nucleotide which is incorporated by means of phosphoramidite chemistry during an automated DNA synthesis method at the 3′ end or at the 5′ end of the DNA strand to be immobilized. The DNA probe molecule is therefore immobilized at its 3′ end or at its 5′ end.

For the case in which ligands are used as the probe molecules, the sulfur functionalities are formed by one end of an alkyl linker or of an alkylene linker, the other end of which has a chemical functionality suitable for the covalent bonding of the ligand, for example a hydroxyl radical, an acetoxy radical or a succinimidyl ester radical.

The electrodes, i.e. in particular the holding regions, are covered during measurement use with an electrolyte 514, in general with a solution to be studied.

If the solution 514 to be studied contains the macromolecular biopolymers to be detected, for example DNA strands to be detected which have a predetermined sequence and which can hybridize with the immobilized DNA probe molecules on the electrodes, then the DNA strands hybridize with the DNA probe molecules.

If the solution 514 to be studied does not contain any DNA strands with the sequence complementary to the sequence of the DNA probe molecules, then no DNA strands from the solution 514 to be studied can hybridize with the DNA probe molecules on the electrodes 501, 502.

FIG. 6 shows a biosensor 600 with a further electrode configuration according to a further exemplary embodiment of the invention.

In the biosensor 600, in the same way as in the biosensor 500 according to the exemplary embodiment shown in FIG. 5, two electrodes 501, 502 are provided which are applied on the insulator layer 503.

In contrast to the biosensor 500 with only two cuboid electrodes, the two electrodes according to the biosensor 600 represented in FIG. 6 are arranged as a plurality of respectively alternately arranged, parallel-connected electrodes in the form of the known interdigitated electrode arrangement.

For further illustration, FIG. 6 also shows a schematic electrical equivalent circuit diagram, which is indicated in the representation of the biosensor 600.

Since essentially uncurved field lines occur with respect to the surface 508 of the insulator layer 503 between the electrode faces 506, 507 of the electrodes 501, 502, which face one another while being essentially parallel, as was represented in FIG. 7, the component of the first capacitance 602 and of the first admittance 603 produced by the uncurved field lines predominates compared with the second capacitance 604 and the second admittance 605, which are produced by the curved field lines 510.

This significantly greater component of the first capacitance 602 and of the first admittance 603 in relation to the total admittance, which is obtained from the sum of the first capacitance 602 and the second capacitance 604 as well as the first admittance 603 and the second admittance 605, has the effect of significantly increasing the sensitivity of the biosensor 600 when the state of the biosensor 600 changes, i.e. when DNA strands in the solution 514 to be studied hybridize with DNA probe molecules 601 immobilized on the holding regions on the electrode faces 506, 507.

Clearly, with the same lateral dimensions of the electrodes 501, 502 and the same dimensions of the previously introduced active region, i.e. with the same area of the holding regions on the electrode faces, a substantially greater component of field lines of an applied electric field between the electrodes 501, 502 is therefore contained in the volume in which the hybridization takes place when DNA strands to be detected are contained in the solution 514 to be studied, than in the case of a planar electrode arrangement.

In other words, this means that the capacitance of the arrangement according to the invention per unit chip area is significantly greater than the capacitance per unit chip area in the case of a planar electrode arrangement.

A few alternative possibilities for producing a cuboid sensor electrode with essentially vertical side walls will be explained below.

First Method for Producing Metal Electrodes With Essentially Vertical Side Walls, Which can Immobilize Probe Molecules

FIG. 7a shows a silicon substrate 700, as is produced for known CMOS processes.

On the silicon substrate 700, which already contains integrated circuits and/or electrical terminals for the electrodes to be formed, an insulator layer 701 which is also used as a passivation layer is applied with a sufficient thickness, with a thickness of 500 nm according to the exemplary embodiment, by means of a CVD method.

The insulator layer 701 may be made of silicon oxide SiO₂ or silicon nitride Si₃N₄.

The interdigitated arrangement of the biosensor 600 according to the exemplary embodiment described above is defined by means of photolithography on the insulator layer 701.

By means of a dry etching method, e.g. reactive ion etching (RIE), steps 702 are subsequently produced, i.e. etched, in the insulator layer 701 with a minimum height 703 of approximately 100 nm according to the exemplary embodiment.

The height 703 of the steps 702 must be large enough for a subsequent self-aligning process to form the metal electrode.

It should be pointed out that an evaporation coating method or a sputtering method may alternatively also be used for applying the insulator layer 701.

During the structuring of the steps 702, care should be taken that the flanks of the steps 702 are steep enough so that they form sufficiently sharp edges 705. An angle 706 of the step flanks, measured with respect to the surface of the insulator layer 701, should be at least 50° according to the exemplary embodiment.

In a further stage, an auxiliary layer 704 (cf. FIG. 7b) made of titanium with a thickness of approximately 10 nm is applied to the stepped insulator layer 701.

The auxiliary layer 704 may comprise tungsten and/or nickel-chromium and/or molybdenum.

It is necessary to guarantee that a metal layer applied in a further stage, according to the exemplary embodiment a metal layer 707 made of gold, grows porously at the edges 705 of the steps 702 so that, in a further method stage, it is possible to respectively etch a gap 708 at the step junctions, into the gold layer 707 which is applied surface-wide.

The gold layer 707 for the biosensor 600 is applied in a further method stage.

According to the exemplary embodiment, the gold layer 707 has a thickness of from approximately 500 nm to approximately 2000 nm.

In terms of the thickness of the gold layer 707, it is merely necessary to guarantee that the thickness of the gold layer 707 is sufficient for the gold layer 707 to grow porously in columns.

In a further stage, openings 708 are etched into the gold layer 7 so that gaps are formed (cf. FIG. 7c).

For wet etching of the openings, an etchant solution made up of 7.5 g Super Strip 100™ (trademark of Lea Ronal GmbH, Deutschland) and 20 g KCN in 1000 ml water H₂O is used.

Owing to the columnar growth of the gold, in general of the metal, during the evaporation coating onto the adhesion layer 704, anisotropic etching attack is achieved so that the surface erosion of the gold takes place approximately in the ratio 1:3.

The gaps 708 are formed as a function of the duration of the etching process by the etching of the gold layer 707.

This means that the duration of the etching process dictates the basic width, i.e. the distance 709 between the gold electrodes 710, 711 which are being formed.

After the metal electrodes have a sufficient width and the distance 709 between the gold electrodes 710, 711 which are being formed is achieved, the wet etching is ended (cf. FIG. 7d).

It should be noted that, because of the porous evaporation coating, etching in a direction parallel to the surface of the insulator layer 701 takes place substantially faster than in a direction perpendicular to the surface of the insulator layer 701.

It should be pointed out that alternatively to a gold layer, it is possible to use another noble metal, for example platinum, titanium or silver, since these materials can likewise have holding regions or can be coated with a suitable material for holding immobilized DNA probe molecules, or in general for holding probe molecules, and they exhibit columnar growth during evaporation coating.

For the case in which the adhesion layer 704 needs to be removed in the opened columns 712 between the metal electrodes 710, 711, this is likewise carried out in a self-aligning fashion by using the gold electrodes 710, 711 as an etching mask.

Compared with the known interdigitated electrodes, the structure according to this exemplary embodiment has the advantage, in particular, that owing to the self-aligning opening of the gold layer 707 over the edges 705, the distance between the electrodes 710, 711 is not tied to a minimum resolution of the production process, i.e. the distance 709 between the electrodes 710, 711 can be kept very narrow.

According to this method, the biosensor 600 according to the exemplary embodiment represented in FIG. 6 with the corresponding metal electrodes is therefore obtained.

Second Method for Producing Metal Electrodes With Essentially Vertical Side Walls, Which can Immobilize Probe Molecules

The production method represented in FIG. 8a to FIG. 8c starts with a substrate 801, for example a silicon substrate wafer (cf. FIG. 8a), on which metallization 802 is already provided as an electrical terminal, an etch stop layer 803 of silicon nitride Si₃N₄ already having been applied on the substrate 801.

A metal layer 804, according to the exemplary embodiment a gold layer 804, is applied on the substrate by means of an evaporation coating method.

Alternatively, a sputtering method or a CVD method may also be used to apply the gold layer 804 to the etch stop layer 803.

In general, the metal layer 804 comprises the metal on which the electrode to be formed is intended to be formed.

An electrically insulating auxiliary layer 805 of silicon oxide SiO₂ is applied on the gold layer 804 by means of a CVD method (alternatively by means of an evaporation coating method or a sputtering method).

By using photolithographic technology, a resist structure, for example a cuboid structure, is formed from a resist layer 806, which resist structure corresponds to the shape of the electrode to be formed.

If a biosensor array, described below, with a plurality of electrodes is to be produced, a resist structure whose shape corresponds to the electrodes to be formed, which form the biosensor array, is produced by means of photolithography.

Put another way, this means that the lateral dimensions of the resist structure which is formed correspond to the dimensions of the sensor electrode to be produced.

The thickness of the resist structure, i.e. the thickness of the resist layer 806, corresponds essentially to the height of the electrodes to be produced.

After application of the resist layer 806 and the corresponding illumination, which defines the corresponding resist structures, the resist layer is removed in the “undeveloped”, i.e. unilluminated regions, for example by means of ashing or wet chemically.

The auxiliary layer 805 is also removed by means of a wet etching method in the regions not protected by the photoresist layer 806.

In a further stage, after removal of the resist layer 806, a further metal layer 807 is applied conformally as an electrode layer over the remaining auxiliary layer 805, in such a way that the side faces 808, 809 of the residual auxiliary layer 805 are covered with the electrode material, according to the exemplary embodiment with gold (cf. FIG. 8b).

The application may be carried out by means of a CVD method or a sputtering method or by using an ion metal plasma method.

In a last stage (cf. FIG. 8c), spacer etching is carried out, during which the desired structure of the electrode 810 is formed by deliberate over-etching of the metal layers 804, 807.

The electrode 810 therefore has the spacers 811, 812, which have not been etched away in the etching stage of etching the metal layers 804, 807, as well as the part of the first metal layer 804, arranged immediately below the residual auxiliary layer 805, which has not been etched away by means of the etching method.

The electrode 810 is electrically coupled to an electrical terminal, i.e. the metallization 802.

The auxiliary layer 805 of silicon oxide may if necessary be removed by further etching, for example in a plasma or wet chemically, by means of a method in which selectivity with respect to the etch stop layer 803 is provided.

This is guaranteed, for example, if the auxiliary layer 805 consists of silicon oxide and the etch stop layer 803 comprises silicon nitride.

The steepness of the walls of the electrode in the biosensor chip 500, 600, represented by the angle 813 between the spacers 811, 812 and the surface 814 of the etch stop layer 803, is therefore determined by the steepness of the flanks of the residual auxiliary layer 805, i.e. in particular the steepness of the resist flanks 815, 816 of the structured resist layer 806.

Third Method for Producing Metal Electrodes With Essentially Vertical Side Walls, Which can Immobilize Probe Molecules

FIG. 9a to FIG. 9c represent a further possibility for producing an electrode with essentially vertical walls.

This also, as represented in the first example of producing an electrode, starts with a substrate 901 on which a metallization 902 is already provided for the electrical terminal of the biosensor electrode to be formed.

A metal layer 903 is evaporation coated as an electrode layer on the silicon substrate 901, the metal layer 903 comprising the material to be used for the electrode, according to this exemplary embodiment gold.

Alternatively to evaporation coating of the metal layer 903, the metal layer 903 may also be applied on the substrate 901 by means of a sputtering method or by means of a CVD method.

A photoresist layer 904 is applied on the metal layer 903 and is structured by means of photolithographic technology so as to produce a resist structure which, after development and removal of the developed regions, corresponds to the lateral dimensions of the electrode to be formed, or in general of the biosensor array to be formed.

The thickness of the photoresist layer 904 corresponds essentially to the height of the electrodes to be produced.

During structuring in a plasma with process gases which cannot lead to any reaction of the electrode material, in particular in an inert gas plasma, for example with argon as the process gas, the erosion of the material according to this exemplary embodiment is carried out by means of physical sputter erosion.

In this case, the electrode material is sputtered from the layer 903 in a redeposition process onto the essentially vertical side walls 905, 906 of the structured resist elements that are not removed after ashing the developed resist structure, where it is no longer exposed to any sputter attack.

Redeposition of electrode material onto the resist structure protects the resist structure from further erosion.

Because of the sputtering, side layers 907, 908 of the electrode material, according to the exemplary embodiment of gold, are formed at the side walls 905, 906 of the resist structure.

The side layers 907, 908 are electrically coupled to an unremoved part 909 of the metal layer 903, which lies immediately below the residual resist structure 906, and furthermore to the metallization 903 (cf. FIG. 9b).

In a last stage (cf. FIG. 9c), the resist structure 906, i.e. the photoresist which is found in the volume formed by the side walls 907, 908 as well as the remaining metal layer 909, is removed by means of ashing or wet chemically.

The result is the electrode structure 910 represented in FIG. 9c, which is formed with the side walls 907, 908 as well as the unremoved part 909, which forms the bottom of the electrode structure and is electrically coupled to the metallization 903.

As in the production method presented above, the steepness of the side walls 907, 908 of the electrode that is formed in this method is determined by the steepness of the resist flanks 905, 906.

FIG. 10a to FIG. 10c represent a further exemplary embodiment of the invention with cylindrical electrodes protruding vertically from the substrate.

In order to produce the biosensor 1000 with cylindrical electrodes, which are arranged essentially vertically on a substrate 1001 of silicon oxide, a metal layer 1002 is applied by means of an evaporation coating method as an electrode layer of the desired electrode material, according to the exemplary embodiment of gold.

A photoresist layer is applied on the metal layer 1002, and the photoresist layer is illuminated by means of a mask so that the cylindrical structure 1003 represented in FIG. 10a is obtained on the metal layer 1002 after the unilluminated regions have been removed.

The cylindrical structure 1003 has a photoresist torus 1004 as well as a cylindrical photoresist ring 1005, which is arranged concentrically around the photoresist torus 1004.

The photoresist is removed between the photoresist torus 1004 and the photoresist ring 1005, for example by means of ashing or wet chemically.

Through the use of a sputtering method, as in conjunction with the method described above for producing an electrode, a metal layer 1006 is applied around the photoresist torus 1004 by means of a redeposition process.

In a similar way, an inner metal layer 1007 is formed around the photoresist ring 1005 (cf. FIG. 10b).

In a further stage, the structured photoresist material is removed by means of ashing or wet chemically, so that two cylindrical electrodes 1008, 1009 are formed.

The substrate 1001 is removed in a last stage, for example by means of a plasma etching process that is selective with respect to the electrode material, to the extent that the metallizations in the substrate are exposed and electrically couple to the cylindrical electrodes.

The inner cylindrical electrode 1008 is therefore electrically coupled to a first electrical terminal 1010, and the outer cylindrical electrode 1009 is electrically coupled to a second electrical terminal 1011.

The residual metal layer 1002, which has not yet been removed by the sputtering between the cylindrical electrodes 1008, 1009, is removed in a last stage by means of a sputter-etching process. The metal layer 1002 is likewise removed in this way.

It should be mentioned in this context that, according to this exemplary embodiment as well, the metallizations for the electrical terminals 1010, 1011 are already provided in the substrate 1001 at the start of the method.

FIG. 11 shows a plan view of a biosensor array 1100, in which cylindrical electrodes 1101, 1102 are contained.

Each first electrode 1101 has a positive electrical potential.

Each second electrode 1102 of the biosensor array 1100 has an electrical potential that is negative in relation to the respectively neighboring first electrode 1101.

The electrodes 1101, 1102 are arranged in rows 1103 and columns 1104.

The first electrode 1101 and the second electrode 1102 are respectively arranged alternately in each row 1103 and each column 1104, i.e. a second electrode 1102 is respectively arranged in a row 1103 or a column 1104 immediately next to a first electrode 1101, and a first electrode 1101 is respectively arranged in a row 1103 or a column 1104 next to a second electrode 1102.

This ensures that an electric field with essentially uncurved field lines in the height direction of the cylinder electrodes 1101, 1102 can be produced between the individual electrodes.

As described above, a large number of DNA probe molecules are respectively immobilized on the electrodes.

If a solution to be studied (not shown) is then applied to the biosensor array 1100, then the DNA strands hybridize with DNA probe molecules complementary thereto which are immobilized on the electrodes.

In this way, by means of the redox recycling process described above, the existence or non-existence of DNA strands of a predetermined sequence in a solution to be studied can in turn be detected by means of the biosensor array 1100.

FIG. 12 shows a further exemplary embodiment of a biosensor array 1200 with a plurality of cuboid electrodes 1201, 1202.

The arrangement of the cuboid electrodes 1201, 1202 is in accordance with the arrangement of the cylindrical electrodes 1201, 1202 as presented in FIG. 12 and explained above.

FIG. 13 shows an electrode arrangement of a biosensor chip 1300 according to a further exemplary embodiment of the invention.

The first electrode 501 is applied on the insulator layer 503 and is electrically coupled to the first electrical terminal 504.

The second electrode 502 is likewise applied on the insulator layer 503 and is electrically coupled to the second electrical terminal 505.

As shown in FIG. 13, the second electrode 502 according to this exemplary embodiment has a different shape compared with the second electrode described previously.

The first electrode, as can be seen from FIG. 13, is a planar electrode and the second electrode is configured with a T-shape.

Each T-shaped second electrode has a first branch 1301, which is arranged essentially perpendicular to the surface 1307 of the insulator layer 703.

Furthermore, the second electrode 502 has second branches 1302 which are arranged perpendicular to the first branch 1301 and are arranged at least partially over the surface 1303 of the respective first electrode 501.

As can be seen in FIG. 13, several first electrodes 501 and several second electrodes 502 are connected in parallel, so that because of the T-shaped structure of the second electrode 502, a cavity 1304 is created which is formed by two second electrodes 502 arranged next to one another, a first electrode 501 and the insulator layer 503.

The individual first and second electrodes 501 and 502 are electrically insulated from one another by means of the insulator layer 503.

An opening 1305 is provided between the individual second branches 1302 of the second electrode 502 for each cavity 1304, which opening 1305 is large enough so that when an electrolyte 1306 is being applied to the biosensor 1300, the electrolyte and DNA strands possibly contained in the solution 1306 to be studied, for example an electrolyte, can pass through the opening 1305 into the cavity 1304.

DNA probe molecules 1309, which can hybridize with the corresponding DNA strands of a predetermined sequence that are to be detected, are immobilized on holding regions on the first and second electrodes.

As can be seen in FIG. 13, because of the mutually facing surfaces, aligned essentially parallel with one another, of the second electrode 1308 and of the first electrode 1303, on which the holding regions for holding the DNA probe molecules 1309 are provided, essentially uncurved field lines are formed when an electric field is applied between the first electrode 501 and the second electrode 502.

FIG. 14 shows a biosensor 1400 according to a further exemplary embodiment of the invention.

The biosensor 1400 according to a further exemplary embodiment corresponds essentially to the biosensor 1300 explained above and shown in FIG. 13, with the difference that no holding regions with immobilized DNA probe molecules 1309 are provided on side walls of the first branch 1301 of the second electrode 502, but rather the surface 1401 of the first branch 1301 of the second electrode 502 is covered with insulator material of the insulator layer 503 or a further insulating layer.

According to the exemplary embodiment shown in FIG. 14, holding regions on the first electrode and on the second electrode 501, 502 are consequently only on directly facing surfaces of the electrodes, i.e. on the surface 1402 of the second branch of the second electrode 502 and on the surface 1403 of the first electrode 501.

FIG. 15a to FIG. 15g represent individual method stages for producing the first electrode 501 and the second electrode 502 in the biosensors 1300, 1400.

In the insulator layer 503 as a substrate, according to the exemplary embodiment made of silicon oxide, a structure whose shape corresponds to the first electrode 501 to be formed is etched into the insulator layer 503 by using a mask layer, for example made of photoresist.

After removal of the layer by ashing or by a wet chemical method, a layer of the desired electrode material is applied surface-wide on the insulator layer 503, in such a way that the previously etched structure 1501 (cf. FIG. 15a) is at least completely filled; the structure 1501 may even be overfilled (cf. FIG. 15b).

In a further stage, the electrode material 1502, preferably gold, located outside the prefabricated structure 1501 is removed by means of a chemical mechanical polishing method (cf. FIG. 15c).

After the completion of the chemical mechanical polishing method, the first electrode 501 is therefore embedded flush in the insular layer 503.

Electrode material 1502 outside, i.e. between the further second electrodes 502 or between the first electrodes 501, is removed without leaving any residue.

A cover layer 1503, for example made of silicon nitride, may furthermore be applied to the first electrode 501 by means of a suitable coating method, for example a CVD method, a sputtering method or an evaporation coating method (cf. FIG. 15d).

FIG. 15e shows several first electrodes 1501 made of gold, which are embedded next to one another in the insulator layer 503, and the cover layer 1503 located on top.

In a further stage (cf. FIG. 15f), a second electrode layer 1504 is applied on the cover layer 1503.

After completed structuring of a mask layer 1506 of, for example, silicon oxide, silicon nitride or photoresist, in which the desired openings 1505 between the second electrodes are taken into account, and which is intended to be formed from the second electrode layer 1504, the desired cavities 1304 are formed according to the biosensors 1300, 1400 represented in FIG. 12 or FIG. 13 in the second electrode layer 1504 over the first electrode layer 1502, by using an isotropic etching method (dry etching method, e.g. in a downstream plasma or wet etching method) (cf. FIG. 15g).

It should be noted in this context that the cover layer 1503 is not absolutely indispensable, but it is advantageous in order to protect the first electrode 501 from superficial etching during the formation of the cavity 1304.

In an alternative embodiment, the T-shaped structure of the second electrode 502 may be formed as follows: after forming the first electrode 501 according to the method described above, a further insulator layer is formed by means of a CVD method or another suitable coating method on the first insulator layer or, if the cover layer 1503 exists, on the cover layer 1503. Subsequently, corresponding trenches are formed in the cover layer 1503, which are used to accommodate the first branch 1301 of the T-shaped structure of the second electrode 502. These trenches are filled with the electrode material gold and, according to the damascene method, the electrode material is removed which has been formed in the trenches and above the second insulator layer by means of chemical mechanical polishing, until a predetermined height which corresponds to the height of the second branch 1302 of the T-shaped second electrode 502.

The opening 1305 between the second electrodes 502 is formed by means of photolithography, and the insulator material is subsequently removed, at least partially, by means of a dry etching method in a downstream plasma from the volume which is intended to be formed as the cavity 1304.

It should furthermore be pointed out that the embodiments described above are not restricted to an electrode whose holding region is produced by means of gold. Alternatively, electrodes may be coated in the holding regions with materials, for example with silicon monoxide or silicon dioxide, which can form a covalent bond with the aforementioned amine, acetoxy, isocyanate, alkysilane residues in order to immobilize probe molecules, in this variant in particular in order to immobilize ligands.

The following publications are cited in this document:

[1] R. Hintsche et al., Microbiosensors Using Electrodes Made in Si-Technology, Frontiers in Biosensorics, Fundamental Aspects, edited by F. W. Scheller et al., Dirk Hauser Verlag, Basel, pp. 267-283, 1997

[2] N. L. Thompson, B. C. Lagerholm, Total Internal Reflection Fluorescence: Applications in Cellular Biophysics, Current Opinion in Biotechnology, Vol. 8, pp. 58-64, 1997

[3] P. Cuatrecasas, Affinity Chromatography, Annual Revision Biochem, Vol. 40, pp. 259-278, 1971

[4] P. van Gerwen, Nanoscaled Interdigitated Electrode Arrays for Biochemical Sensors, IEEE, International Conference on Solid-State Sensors and Actuators, Chicago, pp. 907-910, 16-19 June 1997

1. A method for detecting macromolecular biopolymers by means of an electrode arrangement, which has a first electrode and a second electrode, the first electrode being provided with first molecules which can bind macromolecular biopolymers of a first type, and the second electrode being provided with second molecules which can bind macromolecular biopolymers of a second type,
in which a first electrical measurement is carried out on the electrodes, the first molecules and/or the second molecules being present or not on the electrodes during the first electrical measurement,
in which a medium is brought into contact with the electrodes in such a way that
a) in the event that macromolecular biopolymers of the first type are contained in the medium, they can bind to the first molecules,
b) in the event that macromolecular biopolymers of the second type are contained in the medium, they can bind to the second molecules,
in which unbound first molecules or second molecules are removed from the respective electrode,
in which a second electrical measurement is subsequently carried out between the electrodes,
in which the macromolecular biopolymers are detected on the basis of a comparison of the results of the two electrical measurements on the electrodes.

2. The method as claimed in claim 1,
in which proteins or peptides are detected as the macromolecular biopolymers,
in which ligands, which can specifically bind the proteins or peptides, are used as the first and second molecules.

3. The method as claimed in claim 2, in which unbound first ligands or second ligands are removed from the respective electrode by bringing a material, which is capable of hydrolyzing the chemical bond between the ligand and the electrode, into contact with the electrodes.

4. The method as claimed in claim 3, in which the material which is brought into contact with the electrodes is an enzyme.

5. The method as claimed in claim 4, in which the enzyme which is brought into contact with the electrodes is a carboxyl ester hydrolase (esterase).

6. The method as claimed in claim 1,
in which DNA single strands of a predetermined first sequence are intended to be detected as the macromolecular biopolymers of a first type,
in which DNA single strands of a predetermined second sequence are intended to be detected as the macromolecular biopolymers of a second type,
in which DNA probe molecules with a sequence complementary to the first sequence are used as the first molecules, and
DNA probe molecules with a sequence complementary to the second sequence are used as the second molecules.

7. The method as claimed in claim 6, in which unbound first DNA molecules or second DNA molecules are removed from the respective electrode by bringing an enzyme with nuclease activity into contact with the electrodes.

8. The method as claimed in claim 7, in which at least one of the following substances is used as the enzyme with nuclease activity:
mung bean nuclease,
nuclease P1,
nuclease S1, or
DNA polymerases which are capable of degrading single-stranded DNA owing to their 5′→340 exonuclease activity or their 3′→5′ exonuclease activity.

9. The method as claimed in one of claims 1 to 8, in which an electrolyte is used as the medium.

10. The method as claimed in one of claims 1 to 9, in which the capacitance between the electrodes is measured during the first electrical measurement and the second electrical measurement.

11. The method as claimed in one of claims 1 to 9, in which the electrical resistance of the electrodes is measured during the first electrical measurement and the second electrical measurement.

12. The method as claimed in one of claims 1 to 11, in which an impedance measurement is carried out during the first electrical measurement and the second electrical measurement.
